(19) United States
(12) Patent Application Publication
(10) Pub. No.: US 2015/0137438 A1
(43) Pub. Date: May 21, 2015

(54) Method for Coating an Extension Spring

(71) Applicants: Edward Robert Sonntag, Swift Current (CA); Allan Ross Penner, Herbert (CA)

(72) Inventors: Edward Robert Sonntag, Swift Current (CA); Allan Ross Penner, Herbert (CA)

(73) Assignee: REM ENTERPRISES INC., Swift Current (CA)

(21) Appl. No.: 14/227,602

(22) Filed: Mar. 27, 2014

(30) Foreign Application Priority Data
Nov. 15, 2013 (CA) 2833674

(51) Int. Cl. F16F 1/02; F16F 1/06

(52) U.S. Cl. CPC F16F 1/024; F16F 1/06
USPC 267/166; 427/171

(57) ABSTRACT

A method for coating an extension spring. A helical extension spring is provided. The extension spring has a plurality of coils disposed along a longitudinal axis between a first end portion and a second end portion with the coils touching each other in absence of force acting on the spring that is sufficient for extending the same. The spring is then extended to an extended position. In the extended position the spring has a predetermined distance between successive coils. In the extended position a coating material is disposed onto the surface of the spring such that the coating material is disposed onto a surface portion of the spring where the coils touch each other in absence of extension.

This application claims priority to Canadian Patent Application Serial No. 2,833,674, filed on Nov. 15, 2013 in the name of REM Enterprises Inc. with Bob Sonntag and Allan Penner as inventors. The entire contents of that application are incorporated by reference herein.

### FIELD

The present invention relates to manufacture of extension springs, and more particularly to a method for coating extension springs.

### BACKGROUND

Typical extension springs comprise a plurality of coils disposed along a longitudinal axis between a first end portion and a second end portion and are manufactured in various sizes and pulling forces required for extending the same. In numerous applications the coils of the extension springs touch each other in the absence of pulling force acting on the first and the second end porting of the extension spring that is sufficient for extending the same. Furthermore, for some applications extension springs are provided with the coils pushing against each other creating a “preload.” In use, a sufficiently large initial pulling force has to be applied in order to start the extension of the spring.

In present day manufacturing processes, the interior and exterior of the spring coils of the extension springs are coated while the same are in an un-extended state, thus leaving a helix shaped surface portion of the spring coils where the same touch each other un-coated. This uncoated surface portion typically extends along the complete length of the extension spring.

Unfortunately, during operation—i.e. extension of the spring—this surface portion is exposed to the environment, potentially causing corrosion of the spring coils.

### SUMMARY

Accordingly, one object of the present invention is to provide a method for coating an extension spring such that the coating material is disposed onto a surface portion of the spring where the coils touch each other in absence of extension.

Another object of the present invention is to provide a method for powder coating an extension spring such that the coating material is disposed onto a surface portion of the spring where the coils touch each other in absence of extension.

Another object of the present invention is to provide an extension spring having the coating material is disposed onto a surface portion of the spring where the coils touch each other in absence of extension.

According to one aspect of the present invention, there is provided a method for coating an extension spring. A helical extension spring is provided. The extension spring has a plurality of coils disposed along a longitudinal axis between a first end portion and a second end portion with the coils touching each other in absence of force acting on the spring that is sufficient for extending the same. The spring is then extended to an extended position. In the extended position the spring has a predetermined distance between successive coils. In the extended position a coating material is disposed onto the surface of the spring such that the coating material is disposed onto a surface portion of the spring where the coils touch each other in absence of extension.

According to one aspect of the present invention, there is provided an extension spring. The extension spring comprises a first end portion and a second end portion. A plurality of coils is disposed along a longitudinal axis between the first end portion and the second end portion with the coils touching each other in absence of force acting on the spring that is sufficient for extending the same. A coating material is disposed onto the surface of the spring such that the coating material is disposed onto a surface portion of the spring where the coils touch each other in absence of extension.

One advantage of the present invention is that it provides a method for coating an extension spring such that the coating material is disposed onto a surface portion of the spring where the coils touch each other in absence of extension.

A further advantage of the present invention is that it provides a method for powder coating an extension spring such that the coating material is disposed onto a surface portion of the spring where the coils touch each other in absence of extension.

A further advantage of the present invention is to provide an extension spring having the coating material is disposed onto a surface portion of the spring where the coils touch each other in absence of extension.

### BRIEF DESCRIPTION OF THE DRAWINGS

An embodiment of the present invention is described below with reference to the accompanying drawings, in which:

FIGS. 1a and 1b are simplified block diagrams illustrating a side view of an extension spring according to one embodiment of the invention with the extension spring being un-extended and extended, respectively;

FIGS. 1c and 1d are simplified block diagrams illustrating a perspective view of a detail of the extension spring with the extensions spring being coated using a state of the art coating method and the method for coating an extension spring according to one embodiment of the invention, respectively;

FIGS. 2a and 2b are simplified block diagrams illustrating a top view of the extension spring mounted to a frame structure before extending and after extending, respectively, used in the method for coating an extension spring according to one embodiment of the invention;

FIG. 2c is a simplified block diagram illustrating a top view of extension springs mounted to a frame structure used in the method for coating an extension spring according to one embodiment of the invention; and

FIG. 3 is a simplified flow diagram illustrating the method for coating an extension spring according to one embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of the embodiments hereinbelow is with reference to a method for powder coating an extension spring, it will become evident to those skilled in the art that the embodiments of the invention are not limited thereto, but are also applicable for various other coating processes such as, for example, liquid coating processes, liquid dip processes or plating processes.

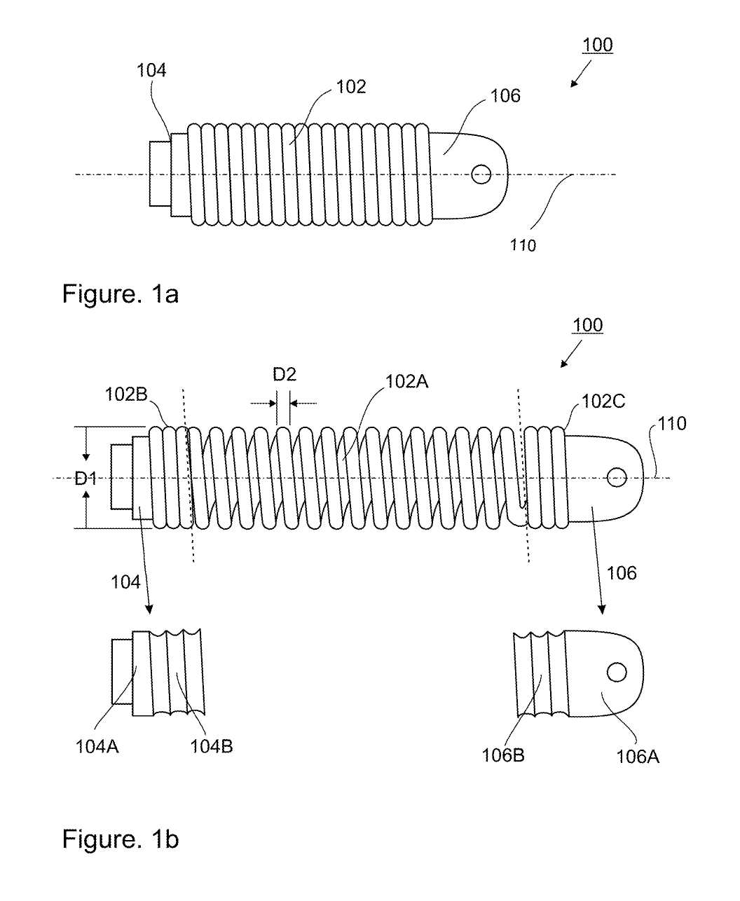

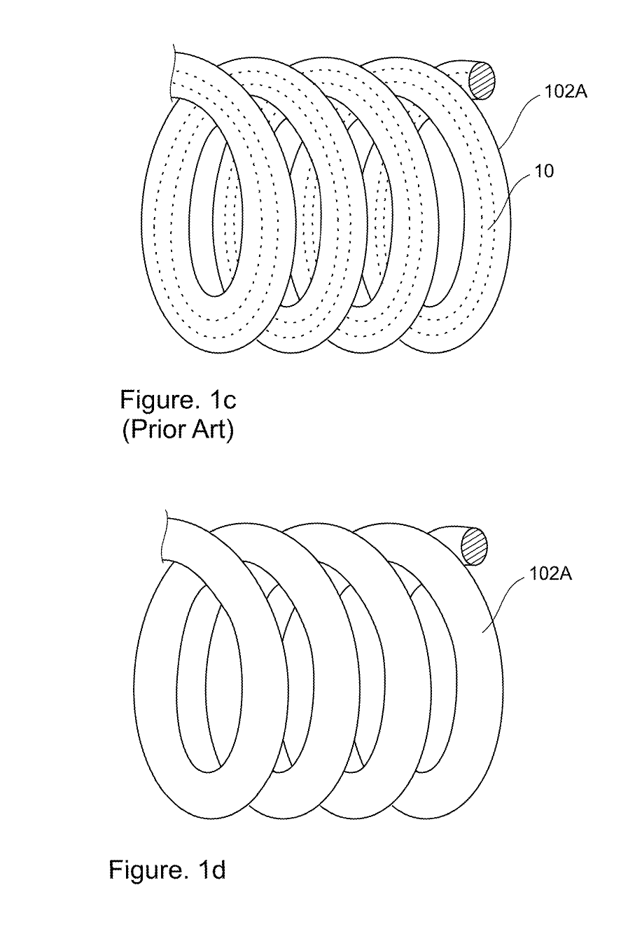

Referring to FIGS. 1a, 1b, and 1d, an extension spring 100 according to one embodiment of the invention is provided. The extension spring 100 comprises coil member 102 and castings 104 and 106. The coil member 102 has a plurality of coils disposed along longitudinal axis 110 between a first end portion and a second end portion with the coils touching each other in absence of pulling force acting on the spring that is sufficient for extending the same. The castings 104, 106 each comprise a mounting portion 104A, 106A and a screw-type coil interacting portion 104B, 106B, respectively. The coil interacting portions 104B, 106B are mounted in a screw type fashion to end portions 102B and 102C of the coil member 102, respectively. With the coils of two end portions 102B and 102C being substantially fixed with respect to each other by interacting with the respective coil interacting portions 104B, 106B of the castings 104, 106, the extension of the spring is provided by the plurality of coils of portion 102A disposed therebetween, as illustrated by the dashed lines in FIG. 1b.

Employment of a state of the art manufacturing process provides coating of the interior and exterior of the spring coils of the portion 102A of coil member 102 while the same are in an un-extended state, thus leaving a helix shaped surface portion 10 of the spring coils where the same touch each other un-coated, as illustrated in FIG. 1c showing an extended section of the portion 102A. This un-coated surface portion 10 extends along the complete length of the extendible section 102A of the extension spring.

Employment of a method for coating an extension spring according to one embodiment of the invention, described hereinbelow, ensures that the coating material is disposed onto the surface portion of the spring where the coils touch each other in absence of extension, as illustrated in FIG. 1d.

Alternatively, an end portion of the first and the last coil of the extension spring is bent to form, for example, a hook or a loop which is attachable, for example, to an eyebolt or a flatbar with a bore. Omission of the castings 104 and 106 enables the coils of the end portions 102B and 102C to expand when exposed to a pulling force.

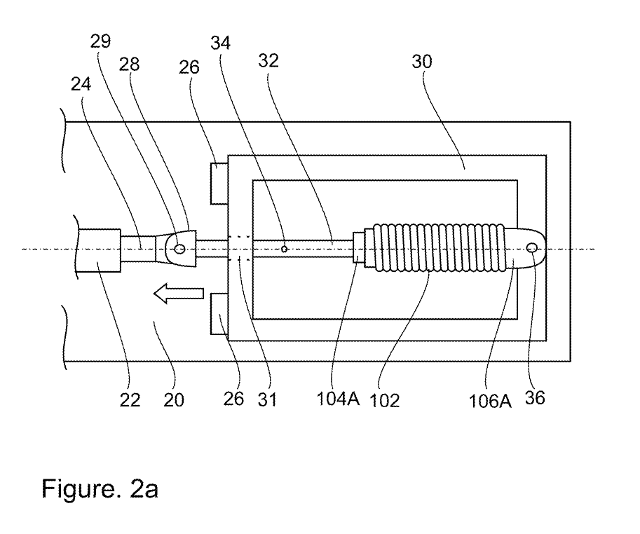

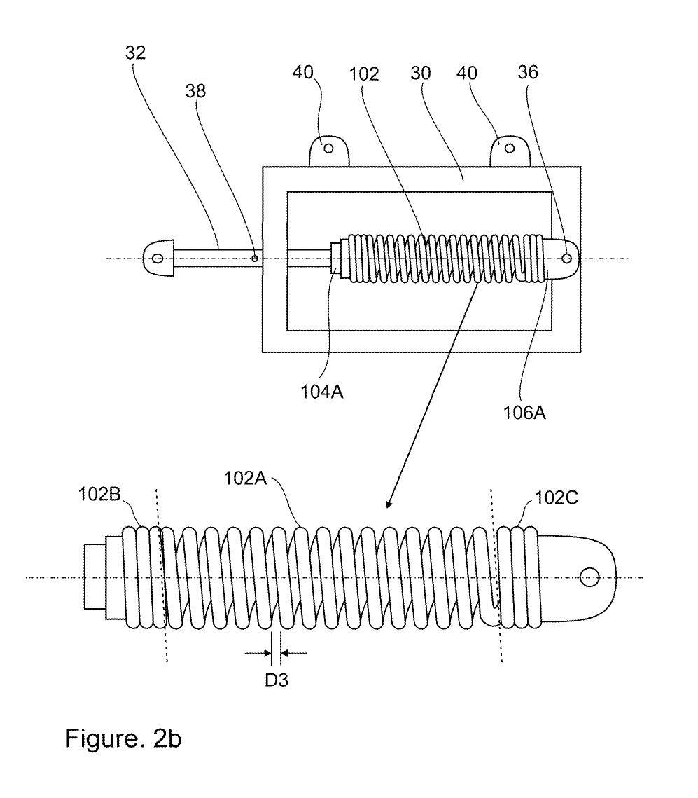

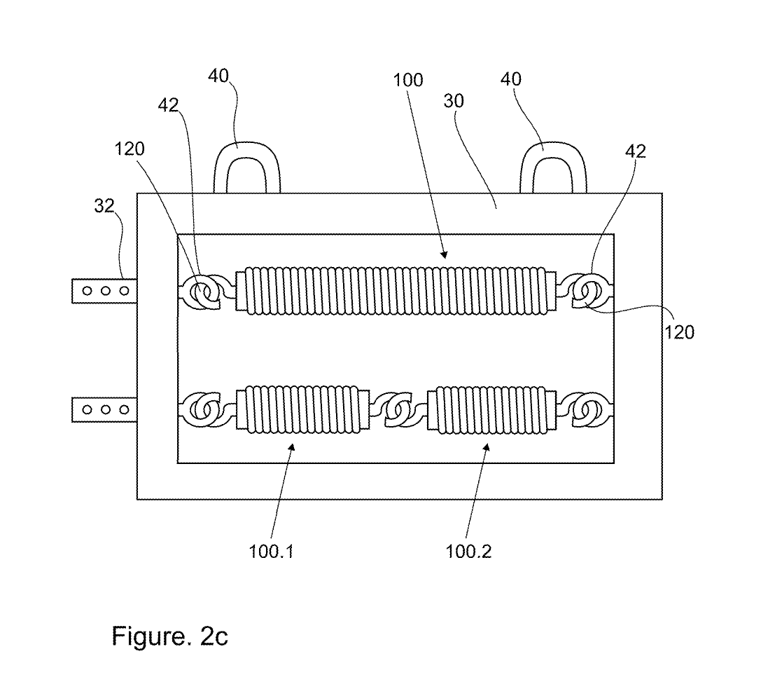

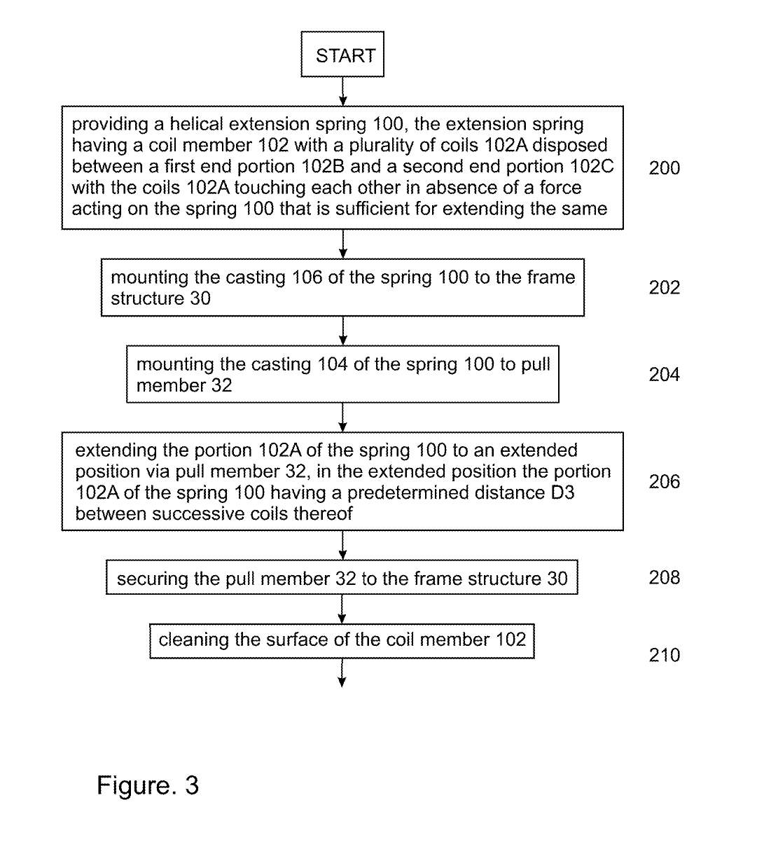

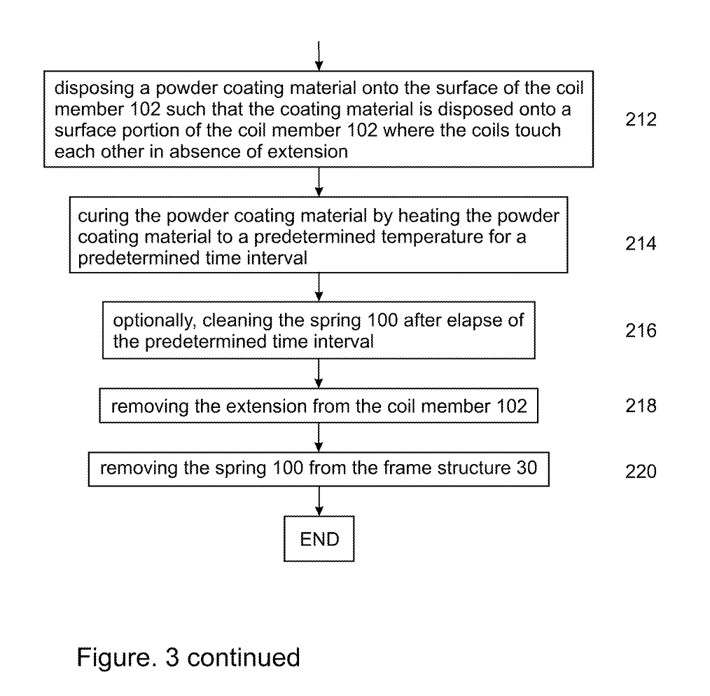

Referring to FIGS. 2a to 2c, and 3, a method for coating an extension spring according to one embodiment of the invention is provided. As will become apparent to those skilled in the art, the method for coating an extension spring according to one embodiment of the invention is easily integrated into existing standard assembly line manufacturing processes. At 200, a helical extension spring such as, for example, extension spring 100 is provided. The extension spring has a coil member 102 with a plurality of coils 102A disposed between a first end portion 102B and a second end portion 102C with the coils 102A touching each other in absence of pulling force acting on the spring 100 that is sufficient for extending the same. The first end portion 102B and the second end portion 102C of the coil member 102 have castings 104 and 106 mounted thereto, respectively. The castings 104 and 106 of the extension spring 100 can be coated prior mounting to the coil member 102.

The casting 106 of the extension spring 100 is then mounted—at 202—to frame structure 30 using, for example, a bolt 36 accommodated in respective bores disposed in the mounting portion 106A of the casting 106 and the frame structure 30, as illustrated in FIG. 2a. The frame structure 30 can be designed as a rectangular frame structure made of a suitable material such as, for example, steel to provide sufficient stability for holding the extension spring 100 in an extended position. The frame structure 30 can be placed onto base 20 and secured thereto prior mounting of the extension spring 100 thereto. Next, the mounting portion 104A of the casting 104 is mounted—at 204—to pull member 32. The pull member 32 comprises, for example, a rod made of steel having a threaded end portion for being mounted to a respective threaded bore disposed in the mounting portion 104A. An opposite end portion of the pull member 32 has a coupling structure 28 for being coupled to an end portion of a pulling actuator such as, for example, piston 24 of hydraulic cylinder 22 mounted to the base 20. For example, the coupling structure 28 of the pull member 32 and the end portion of the piston 24 each comprise a bore and are then connected by bolt 29 accommodated therein. Of course, various other actuators such as, for example, a rack and pinion actuator, may be employed. The frame structure 30 can comprise bore 31 for longitudinal movable accommodating pull member 32 therein. At 206, the portion 102A of the spring 100 is extended to a predetermined extended position using hydraulic cylinder 22 for pulling—as indicated by the block arrow—pull member 32 coupled to the piston 24 while the frame structure 30 is abutted at blocks 26 mounted to the base 20. In the predetermined extended position, the portion 102A of the spring 100 has a predetermined distance D3 between successive coils thereof, as illustrated in the detail of FIG. 2b.

The distance D3 can be determined such that it is just sufficiently large to allow thorough coating of the space between successive coils, in order to substantially minimize the force acting on the frame structure 30 and the stress acting on the extension spring 100. It is noted that heat curing—applied, for example, in powder coating processes—tends to relieve the additional stress in the extension spring resulting, for example, in a decreased preload. By substantially minimizing the extension of the spring—i.e. the distance D3—during heat curing it is possible to coat the surface portion of the spring where the coils touch each other in absence of extension while substantially preserving the initial characteristics of the extension spring such as, for example, the spring constant and the preload. The distance D3 is determined, for example, in dependence upon characteristics of the coating process employed such as, for example, the geometry of the spray nozzle and particle size of the coating material, as well as, the geometry of the extension spring such as, for example, the diameter D1 and the thickness D2 of the coils.

After extending the spring 100, the pull member 32 is secured—at 208—to the frame structure 30, for example, by abutting the pull member 32 to the frame structure 30 via bolt 38 accommodated in bore 34 disposed in the pull member 32 at the respective location for holding the spring 100 in the predetermined extended position. The pull member 32 is then decoupled from the piston 24 allowing the frame structure 30, together with the extended spring 100, to be removed from the base 20 for performing the steps according to the coating process. The frame structure 30 can comprise holding elements 40 such as, for example, hooks, loops or bores for attaching the same to respective transport equipment of an assembly line.

Alternatively, hooks or loops 42 are mounted to the frame structure 30 and the pull member 32 in a conventional manner using, for example, welding or screw fastening. For example, as illustrated in FIG. 2c, mounting hooks 120 of the extension spring 100 are inserted into respective loops 42. Optionally, two or more springs 100.1, 100.2 are mounted in series to the frame structure 30, for example, by connecting a mounting hook 120 of spring 100.1 to a respective mounting hook of spring 100.2, as illustrated in FIG. 2c. As is evident, the springs 100.1 and 100.2 may be connected in different fashion using, for example, a screw bolt interposed in respective loops or bores of the springs. Further optionally, two or more springs are connected in parallel.

At 210, the surface of the coil member 102 is cleaned using, for example, a washing & drying process or an abrasive cleaning process such as blasting in dependence upon the material of the coil member 102 and the coating process to be applied. As is evident, cleaning the extension spring in the extended position is more thorough than cleaning the extension spring when un-extended by enabling cleaning of hard to reach spaces between successive coils. In the following, a coating material such as, for example, a powder coating material is disposed—at 212—onto the surface of the coil member 102 such that the coating material is disposed onto a surface portion of the coil member 102 where the coils touch each other in absence of extension. The powder coating material is then cured—at 214—by heating the same to a predetermined temperature for a predetermined time interval. Optionally, after elapse of the predetermined time interval the spring 100 is cleaned using compressed air—at 216—to remove excess material and grit. For example, depending on the design of the castings 104, 106 the cleaning step 216 can be added to remove the excess material and grit accumulated at the castings. Optionally, depending on the coating process applied such as, for example, spray painting, heating is omitted and the coating material is cured at room temperature.

The frame structure 30 with the coated spring 100 is then placed again onto base 20 and secured thereto. After coupling the pull member 32 to the piston 24 and using the hydraulic cylinder 22 for applying sufficient pulling force, the bolt 38 is removed and the pulling force is then decreased for removing—at 218—the extension from the coil member 102. The pulling member is then decoupled from the piston 24 and removed from the mounting portion 104A of the casting 104. After removal of the bolt 36, the spring 100 is removed—at 220—from the frame structure 30. The same process is then repeated starting at 200 for another extension spring. A plurality of frame structures 30 can be employed in an assembly line process.

In an exemplary implementation, the process has been employed for powder coating a spring having: a coil diameter D1 of 3.75 inch; a coil thickness D2 of 0.625 inch; 34 coils in the extendible section 102A; a maximum extension of 9.9375 inch; a load rate of 211.397 pounds/inch; and a preload of 750 pounds. For the powder coating process the spring is extended by 5.63 inch giving a predetermined distance D3 of 0.16 inch.

The spring has been powder coated to a cured thickness of 4-6 mil using a standard DuPont coating powder. The powder coating has been cured at a temperature of 400° F. for a minimum of 15 minutes or at a temperature of 350° F. for a minimum of 25 minutes.

As is evident, the above method for coating an extension spring according to one embodiment of the invention is also employable for coating various different sizes of extension springs as well as types of extension springs such as, for example, extension springs with the end portion of the first and the last coil being bent to form, for example, a hook or loop, by adapting the frame structure 30 and the end portion of the pull member 32 accordingly.

Furthermore, the frame structure 30 is not limited to a rectangular frame, but various other shapes are employable such as, for example, a C-shape as long as the structure is sufficiently strong for holding the spring in the extended position.

Optionally, more than one base and pulling actuator are employed, for example, a first base and pulling actuator for mounting the spring to the frame structure and extending the same, and a second base and pulling actuator for removing the extension of the spring and removing the same from the frame structure.

The present invention has been described herein with regard to certain embodiments. However, it will be obvious to persons skilled in the art that a number of variations and modifications can be made without departing from the scope of the invention as described herein.

What is claimed is:

1. A method for coating an extension spring comprising:
providing a helical extension spring, the extension spring having a plurality of coils disposed along a longitudinal axis between a first end portion and a second end portion with the coils touching each other in absence of a force acting on the spring that is sufficient for extending the same;
extending the spring to an extended position, in the extended position the spring having a predetermined distance between successive coils thereof; and
in the extended position disposing a coating material onto the surface of the spring such that the coating material is disposed onto a surface portion of the spring where the coils touch each other in absence of extension.

2. The method according to claim 1 comprising:
curing the coating material for a predetermined time interval while the spring is extended; and,
removing the extension from the spring after elapse of the predetermined time interval.

3. The method according to claim 2 comprising cleaning the surface of the spring in the extended position prior disposing the coating material.

4. The method according to claim 3 wherein cleaning the surface of the spring comprises washing of the surface of the spring and drying.

5. The method according to claim 3 wherein cleaning the surface of the spring comprises abrasive cleaning of the surface of the spring.

6. The method according to claim 3 comprising cleaning the coated spring in the extended position after curing the coating material.

7. The method according to claim 2 wherein curing the coating material comprises heating the coating material to a predetermined temperature.

8. The method according to claim 7 wherein disposing the coating material comprises powder coating.

9. The method according to claim 1 comprising:
mounting the first end portion of the spring to a frame structure; and
mounting the second end portion of the spring to the frame structure after extending the spring.

10. An extension spring comprising:
a first end portion and a second end portion;
a plurality of coils disposed along a longitudinal axis between the first end portion and the second end portion with the coils touching each other in absence of a force acting on the spring that is sufficient for extending the same; and
a coating material disposed onto the surface of the spring such that the coating material is disposed onto a surface portion of the spring where the coils touch each other in absence of extension.

11. The extension spring according to claim 10 wherein the coating material is a powder coating material.

12. The extension spring according to claim 10 wherein the coils are preloaded.
